(19) United States
(12) Patent Application Publication
(10) Pub. No.: US 2019/0061775 A1
(43) Pub. Date: Feb. 28, 2019

(54) DRIVING SUPPORT DEVICE, AUTONOMOUS DRIVING CONTROL DEVICE, VEHICLE, DRIVING SUPPORT METHOD, AND PROGRAM

(71) Applicant: Panasonic Intellectual Property Management Co., Ltd., Osaka (JP)

(72) Inventors: KOICHI EMURA, Kanagawa (JP); TAKUMA MASUDA, Kanagawa (JP)

(21) Appl. No.: 16/078,351

(22) PCT Filed: Jan. 25, 2017
(86) PCT No.: PCT/JP2017/002439

§ 371 Date: Aug. 21, 2018

(30) Foreign Application Priority Data
Mar. 31, 2016 (JP) 2016-072731

(51) Int. Cl. B60W 50/02; G05D 1/00; B60W 50/14

(52) U.S. Cl. CPC B60W 50/0205; G05D 1/0088; G05D 1/0061; B60W 2050/146; G05D 2201/0213; B60W 2050/0215; B60W 50/14

(57) ABSTRACT

A driving support device includes a monitoring unit and an output unit. The monitoring unit monitors whether a sensor to be mounted on a vehicle is operating. The output unit outputs operation-state information indicating a result of the monitoring by the monitoring unit. The monitoring unit detects malfunction of the sensor based on detection accuracy of the sensor. The detection accuracy is received when the sensor operates. The output unit outputs malfunction information on the malfunction of the sensor together with the operation-state information when the monitoring unit detects the malfunction of the sensor.

### TECHNICAL FIELD

The present invention relates to a driving support device, an autonomous driving control device, a vehicle, a driving support method, and a program.

### BACKGROUND ART

If a lane change is attempted in a direction where an obstacle is present when the obstacle is present in a rear side of a vehicle, a rear side obstacle warning system issues a notice that the obstacle is present on the rear side. In the rear side obstacle warning system, a display unit for telling the presence of the obstacle is provided on a door mirror, and a failure notification unit is provided on an instrument panel. Accordingly, it is difficult to surely understand whether or not the rear side obstacle warning system is out of order. Therefore, the failure notification unit is provided on the door mirror (for example, refer to PTL 1).

### CITATION LIST

### Patent Literature

PTL 1: Unexamined Japanese Patent Publication No. 2007-1436

### SUMMARY OF THE INVENTION

The present invention provides a technique for collectively issuing information regarding a sensor mounted on a vehicle.

A driving support device according to an aspect of the present invention includes: a monitoring unit that monitors whether a sensor to be mounted on a vehicle is operating; and an output unit that outputs operation-state information indicating a result of the monitoring by the monitoring unit. The monitoring unit detects malfunction of the sensor based on detection accuracy of the sensor. The detection accuracy is received when the sensor operates. The output unit outputs malfunction information on the malfunction of the sensor together with the operation-state information when the monitoring unit detects the malfunction of the sensor.

Another aspect of the present invention provides an autonomous driving control device. The autonomous driving control device includes: a monitoring unit that monitors whether a sensor to be mounted on a vehicle is operating; an output unit that outputs operation-state information indicating a result of the monitoring by the monitoring unit; and an autonomous driving controller that controls autonomous driving of the vehicle based on a detection result of the sensor. The monitoring unit detects malfunction of the sensor based on detection accuracy of the sensor. The detection accuracy is received when the sensor operates. The output unit outputs malfunction information on the malfunction of the sensor together with the operation-state information when the monitoring unit detects the malfunction.

Still another aspect of the present invention provides a vehicle. The vehicle includes a driving support device. The driving support device includes: a monitoring unit that monitors whether a sensor to be mounted on a vehicle is operating; and an output unit that outputs operation-state information indicating a result of the monitoring by the monitoring unit. The monitoring unit detects malfunction of the sensor based on detection accuracy of the sensor. The detection accuracy is received when the sensor operates. The output unit malfunction information on the malfunction of the sensor together with the operation-state information when the monitoring unit detects the malfunction.

Still another aspect of the present invention also provides a driving assistance method. A driving support method includes: monitoring whether a sensor to be mounted on a vehicle is operating; outputting operation-state information indicating a result of the monitoring by the monitoring unit; detecting malfunction of the sensor based on detection accuracy of the sensor, the detection accuracy being received when the sensor operates; and outputting malfunction information on the malfunction of the sensor together with the operation-state information when the malfunction of the sensor is detected.

Note that arbitrary combinations of the above constituents and any conversions of expressions of the present invention made among devices, systems, methods, programs, recording media recording programs, vehicles equipped with the devices, and the like are also effective as aspects of the present invention.

According to the present invention, information regarding a sensor mounted on a vehicle can be issued collectively.

### BRIEF DESCRIPTION OF DRAWINGS

FIG. 1 is a diagram illustrating a configuration of a vehicle according to an exemplary embodiment.

FIG. 2 is a view schematically illustrating an interior of the vehicle in FIG. 1.

FIG. 3 is a diagram illustrating a configuration of a controller in FIG. 1.

FIG. 4 is a view illustrating a direction of an obstacle detected by a sensor in FIG. 1.

FIG. 5A is a view illustrating an image generated by an image generator in FIG. 3.

FIG. 5B is a view illustrating the image generated by the image generator in FIG. 3.

FIG. 5C is a view illustrating the image generated by the image generator in FIG. 3.

FIG. 5D is a view illustrating the image generated by the image generator in FIG. 3.

FIG. 5E is a view illustrating the image generated by the image generator in FIG. 3.

FIG. 5F is a view illustrating the image generated by the image generator in FIG. 3.

FIG. 6A is a view illustrating another image generated by the image generator in FIG. 3.

FIG. 6B is a view illustrating another image generated by the image generator in FIG. 3.

FIG. 7A is a view illustrating still another image generated by the image generator in FIG. 3.

FIG. 7B is a view illustrating still another image generated by the image generator in FIG. 3.

FIG. 8 is a flowchart illustrating an output procedure by the controller in FIG. 3.

### DESCRIPTION OF EMBODIMENT

Prior to description of an exemplary embodiment of the present invention, problems found in a conventional technique will briefly be described herein. In general, a plurality of sensors are mounted on a vehicle capable of executing autonomous driving. Presence of an obstacle is detected based on detection results in the plurality of sensors. Moreover, a direction where the obstacle is present or the like is displayed on a display in order to notify a driver of the presence of the obstacle. However, there is a problem that the driver is not notified whether or not the sensors are operating and whether or not detection accuracy by the sensors is low.

Prior to specific description of the exemplary embodiment of the present invention, an outline of the present invention will be described herein. The exemplary embodiment relates to notification of information about sensors to be used for autonomous driving of a vehicle. In particular, the present exemplary embodiment relates to a device (hereinafter also referred to as a “driving support device”) that controls a human machine interface (HMI) for exchanging information regarding a driving behavior of the vehicle with an occupant (for example, driver) of the vehicle. The “driving behavior” includes an operating state such as steering and braking during traveling and stopping of the vehicle, or control contents related to autonomous driving control. For example, the driving behavior is constant speed traveling, acceleration, deceleration, pause, stop, lane change, course change, right/left turn, parking, or the like. Moreover, the driving behavior may be cruising (running while keeping a lane and maintaining a vehicle speed), lane keeping, following a preceding vehicle, stop and go during following, lane change, passing, addressing a merging vehicle, crossover (interchange) including entry and exit to and from an expressway, merging, addressing a construction zone, addressing an emergency vehicle, addressing an interrupting vehicle, addressing lanes exclusive to right/left turns, interaction with a pedestrian/bicycle, avoidance of an obstacle other than a vehicle, addressing a sign, addressing restrictions of right/left turns and a U turn, addressing lane restriction, addressing one-way traffic, addressing a traffic sign, addressing an intersection/roundabout, or the like.

When the vehicle executes the autonomous driving, the presence of the obstacle is detected based on the detection results in the sensors, and the driving behavior is determined so that the obstacle is avoided. Moreover, the vehicle travels in accordance with the determined driving behavior. At this time, information regarding the detected obstacle or the like is displayed on the display, whereby the driver is notified of the presence of the obstacle. Meanwhile, when manual driving is executed in the vehicle, the presence of the obstacle is detected based on the detection results of the sensors, and the information regarding the detected obstacle or the like is displayed on the display, whereby the vehicle is driven so as to avoid the obstacle. Moreover, with regard to the sensors, it is preferable that the driver be also notified of information about operation/non-operation, information about malfunction, and information about a detection range corresponding to a travel state of the vehicle. It is preferable that these pieces of information be displayed on the display together with the information regarding the obstacle in order to cause the information to alert the driver.

Hereinafter, the exemplary embodiment of the present invention will be described in detail with reference to the drawings. Note that each exemplary embodiment described below is only illustrative, and does not limit the present invention.

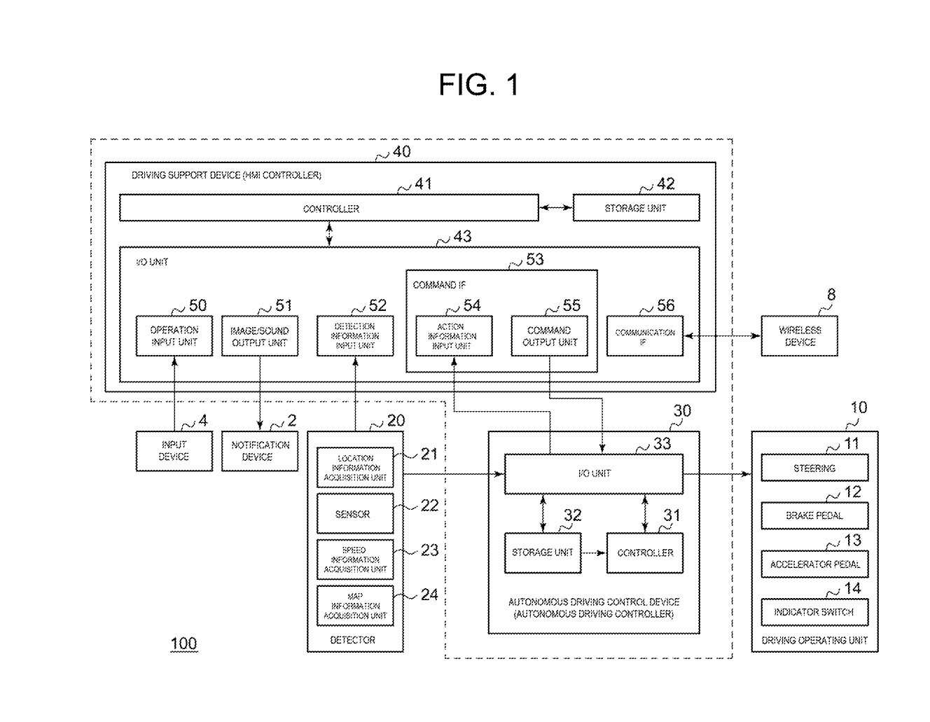

FIG. 1 illustrates a configuration of vehicle 100 according to the exemplary embodiment, and particularly illustrates a configuration related to autonomous driving. Vehicle 100 can travel in an autonomous driving mode, and includes notification device 2, input device 4, wireless device 8, driving operating unit 10, detector 20, autonomous driving control device 30, and driving support device (HMI controller) 40. The devices illustrated in FIG. 1 may be interconnected by exclusive lines or wire communication such as controller area network (CAN). Alternatively, the devices may be interconnected by wire communication or wireless communication such as a universal serial bus (USB), Ethernet (registered trademark), Wi-Fi (registered trademark) and Bluetooth (registered trademark).

Notification device 2 notifies the driver of information regarding travel of vehicle 100. Notification device 2 is a display for displaying information, such as a light emitter, for example, a light emitting diode (LED) provided on a car navigation system, a head-up display, a center display, a steering wheel, a pillar, a dashboard, and a vicinity of an instrument panel, those of which are installed in a vehicle interior. Moreover, notification device 2 may be a speaker for notifying the driver of information converted into a sound, or may be a vibrator provided on a position (for example, a seat of the driver, a steering wheel, or the like) where the driver can sense vibrations. Furthermore, notification device 2 may be a combination of these elements. Input device 4 is a user interface device that receives an operation input performed by an occupant. For example, input device 4 receives information regarding autonomous driving of the subject vehicle, the information having been input by the driver. Input device 4 outputs the received information to driving support device 40 as an operation signal.

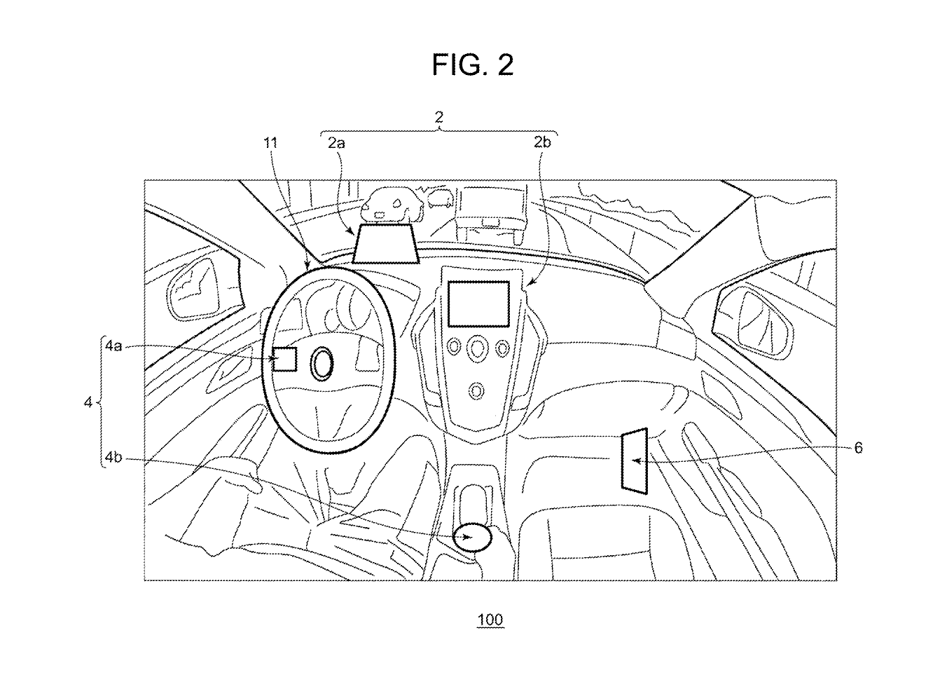

FIG. 2 schematically illustrates an interior of vehicle 100. Notification device 2 may be head-up display (HUD) 2a or center display 2b. Input device 4 may be first operating unit 4a mounted on steering 11 or second operating unit 4b mounted between a driver seat and a passenger seat. Note that notification device 2 and input device 4 may be integrated with each other, and for example, may be mounted as a touch panel display. Speaker 6 for presenting information regarding the autonomous driving to the occupant with a sound may be mounted on vehicle 100. In this case, driving support device 40 may cause notification device 2 to display an image indicating information regarding the autonomous driving, and in addition to or in place of this configuration, may output a sound indicating the information regarding the autonomous driving from speaker 6. The description returns to FIG. 1.

Wireless device 8 is adapted to a mobile phone communication system, wireless metropolitan area network (WMAN) or the like, and executes wireless communication. Driving operating unit 10 includes steering wheel 11, brake pedal 12, accelerator pedal 13, and indicator switch 14. Steering 11, brake pedal 12, accelerator pedal 13 and indicator switch 14 can be electronically controlled by a steering electronic control unit (ECU), a brake ECU, at least one of an engine ECU and a motor ECU, and an indicator controller, respectively. In the autonomous driving mode, the steering ECU, the brake ECU, the engine ECU, and the motor ECU drive actuators according to control signals supplied from autonomous driving control device 30. In addition, the indicator controller turns on or off an indicator lamp according to a control signal supplied from autonomous driving control device 30.

Detector 20 detects a surrounding situation and travel state of vehicle 100. For example, detector 20 detects a speed of vehicle 100, a relative speed of a preceding vehicle with respect to vehicle 100, a distance between vehicle 100 and the preceding vehicle, a relative speed of a vehicle in an adjacent lane with respect to vehicle 100, a distance between vehicle 100 and the vehicle in the adjacent lane, and location information of vehicle 100. Detector 20 outputs the various pieces of detected information (hereinafter referred to as “detection information”) to autonomous driving control device 30 and driving support device 40. Detector 20 includes location information acquisition unit 21, sensor 22, speed information acquisition unit 23, and map information acquisition unit 24.

Location information acquisition unit 21 acquires a current location of vehicle 100 from a global positioning system (GPS) receiver. Sensor 22 is a general term for various sensors for detecting a situation outside the vehicle and the state of vehicle 100. As the sensor for detecting the situation outside the vehicle, for example, a camera, a millimeter-wave radar, a light detection and ranging, laser imaging detection and ranging (LIDAR), a temperature sensor, an atmospheric pressure sensor, a humidity sensor, and an illuminance sensor are mounted. The situation outside the vehicle includes a situation of a road where the subject vehicle travels, which includes lane information, an environment including weather, a surrounding situation of the subject vehicle, and other vehicles (such as other vehicles traveling in the adjacent lane) present nearby. Note that any information may be included as long as the information is vehicle exterior information that can be detected by sensor 22. Moreover, as the sensor 22 for detecting the state of vehicle 100, for example, an acceleration sensor, a gyroscope sensor, a geomagnetism sensor, and an inclination sensor are mounted.

Speed information acquisition unit 23 acquires the current speed of vehicle 100 from a speed sensor. Map information acquisition unit 24 acquires map information around the current location of vehicle 100 from a map database. The map database may be recorded in a recording medium in vehicle 100, or may be downloaded from a map server via a network when being used.

Autonomous driving control device 30 is an autonomous driving controller having an autonomous driving control function mounted thereto, and determines a behavior of vehicle 100 in autonomous driving. Autonomous driving control device 30 includes controller 31, storage unit 32, and input/output (I/O) unit 33. A configuration of controller 31 can be implemented by cooperation between hardware resources and software resources or by only hardware resources. Hardware resources which can be used include a processor, a read only memory (ROM), a random access memory (RAM), and other large scale integrations (LSIs). Software resources which can be used include programs such as an operating system, applications, and firmware. Storage unit 32 has a non-volatile recording medium such as a flash memory. I/O unit 33 executes communication control according to various communication formats. For example, I/O unit 33 outputs information regarding the autonomous driving to driving support device 40, and receives a control command from driving support device 40. I/O unit 33 receives the detection information from detector 20.

Controller 31 applies the control command input from driving support device 40 and the various pieces of information collected from detector 20 or the various ECUs to an autonomous driving algorithm, thereby calculating control values for controlling autonomous control targets such as a travel direction of vehicle 100. Controller 31 transmits the calculated control values to the ECUs or the controllers as the respective control targets. In the present exemplary embodiment, controller 31 transmits the calculated control values to the steering ECU, the brake ECU, the engine ECU, and the indicator controller. Note that, in a case of an electrically driven vehicle or a hybrid car, controller 31 transmits the control values to the motor ECU in place of or in addition to the engine ECU.

Driving support device 40 is an HMI controller executing an interface function between vehicle 100 and the driver, and includes controller 41, storage unit 42, and I/O unit 43. Controller 41 executes a variety of data processing such as HMI control. Controller 41 can be implemented by cooperation between hardware resources and software resources or by only hardware resources. Hardware resources which can be used include a processor, a ROM, a RAM, and other LSIs. Software resources which can be used include programs such as an operating system, applications, and firmware.

Storage unit 42 is a storage area for storing data which is referred to or updated by controller 41. For example, storage unit 42 is implemented by a non-volatile recording medium such as a flash memory. I/O unit 43 executes various types of communication controls corresponding to various types of communication formats. I/O unit 43 includes operation input unit 50, image/sound output unit 51, detection information input unit 52, command interface (IF) 53, and communication IF 56.

Operation input unit 50 receives, from input device 4, an operation signal input by an operation performed for input device 4 by the driver, the occupant, or a user outside of vehicle 100, and outputs this operation signal to controller 41. Image/sound output unit 51 outputs image data or a sound message, which is generated by controller 41, to notification device 2 and causes notification device 2 to display this image data or sound data. Detection information input unit 52 receives, from detector 20, information (hereinafter referred to as “detection information”) which is a result of the detection process performed by detector 20 and indicates the current surrounding situation and travel state of vehicle 100, and outputs the received information to controller 41.

Command IF 53 executes an interface process with autonomous driving control device 30, and includes action information input unit 54 and command output unit 55. Action information input unit 54 receives information regarding the autonomous driving of vehicle 100, the information having been transmitted from autonomous driving control device 30. Then, action information input unit 54 outputs the received information to controller 41. Command output unit 55 receives, from controller 41, a control command which indicates a manner of the autonomous driving to autonomous driving control device 30, and transmits this command to autonomous driving control device 30.

Communication IF 56 executes an interface process with wireless device 8. Communication IF 56 transmits the data, which is output from controller 41, to wireless device 8, and transmits this data to an external device from wireless device 8. Moreover, communication IF 56 receives data transmitted from the external device, the date having been transferred by wireless device 8, and outputs this data to controller 41.

Note that, herein, autonomous driving control device 30 and driving support device 40 are configured as individual devices. As a modification, autonomous driving control device 30 and driving support device 40 may be integrated into one controller as indicated by a broken line in FIG. 1. In other words, a single autonomous driving control device may have a configuration of having both of the functions of autonomous driving control device 30 and driving support device 40 in FIG. 1.

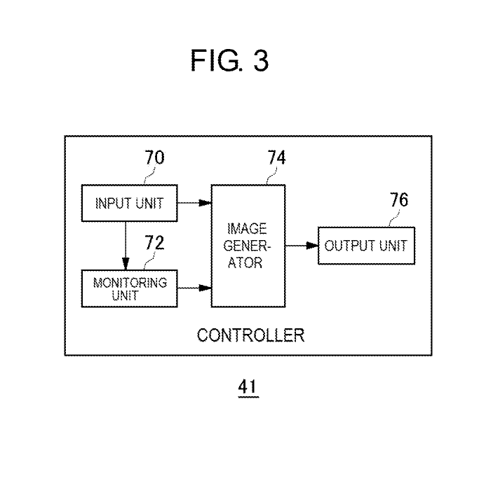

FIG. 3 illustrates a configuration of controller 41. Controller 41 includes input unit 70, monitoring unit 72, image generator 74 and output unit 76. Monitoring unit 72 is connected to sensor 22 via I/O unit 43 in FIG. 1, and monitors operation/non-operation of sensor 22. For example, monitoring unit 72 monitors whether a power source of sensor 22 is on or off, determines that sensor 22 is operating when the power source is on, and determines that the sensor 22 is not operating when the power source is off. Note that a known technique just needs to be used for confirming whether the power source of sensor 22 is on or off. As mentioned above, sensor 22 is a general term for the various sensors for detecting the situation outside the vehicle. Therefore, a plurality of sensors 22 are provided in all directions of vehicle 100 so as to be capable of detecting the surrounding situation of vehicle 100. Monitoring unit 72 monitors the operation/non-operation for each of the plurality of sensors 22. Monitoring unit 72 outputs the operation/non-operation for each of sensors 22 to image generator 74.

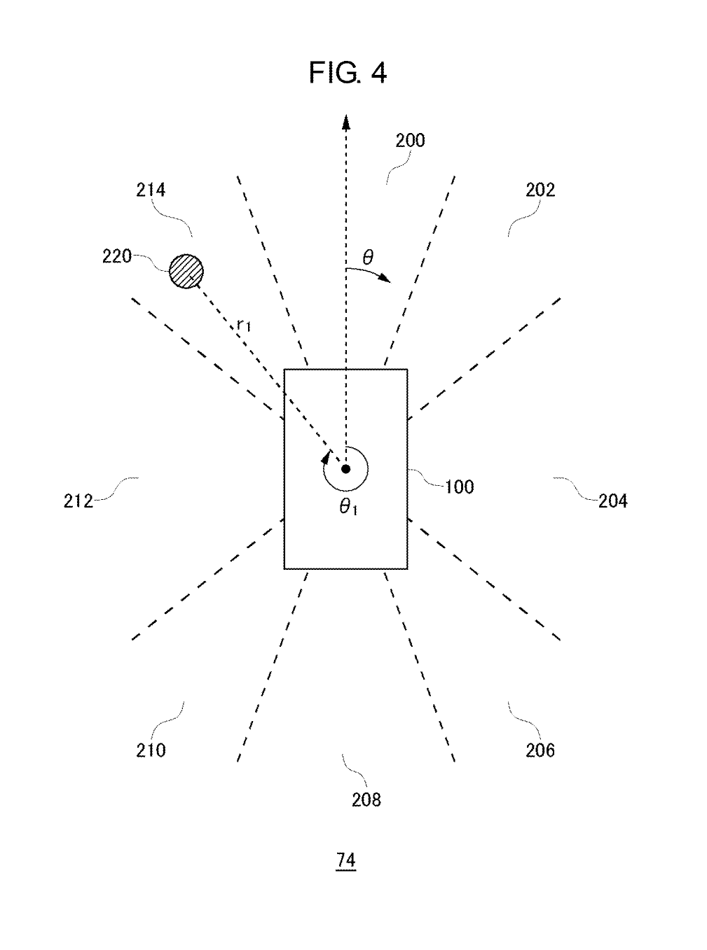

Input unit 70 is connected to each of sensors 22 via I/O unit 43, and receives the detection result from each of sensors 22 when sensor 22 is operating. The detection result from sensor 22 indicates a direction and the like of the obstacle when the obstacle is detected. Now, FIG. 4 will be referred to in order to describe the direction of the obstacle. FIG. 4 is a view illustrating a direction of the obstacle detected by sensor 22. For example, such a coordinate system is defined, in which the front of vehicle 100 is “0°” and an angle θ increases clockwise with vehicle 100 is taken at the center. In such a coordinate system, it is detected that obstacle 220 is present in a direction of an angle “θ1” and at a distance of “r1”. Note that a common coordinate system is defined for the plurality of sensors 22. Therefore, when the detection results are input individually from the plurality of sensors 22, the directions and the like of obstacle 220 are synthesized on the common coordinate system in input unit 70. The description returns to FIG. 3.

When input unit 70 receives the detection result from each of sensors 22, input unit 70 also receives detection accuracy for the detection result in sensor 22. That is, monitoring unit 72 receives the detection accuracy of sensor 22 when sensor 22 is operating. The detection accuracy is a value indicating a probability of obstacle 220 thus detected, and for example, increases as the detection result becomes more accurate. Note that the detection accuracy is a value different depending on a type of sensor 22. Input unit 70 outputs the direction of obstacle 220 to image generator 74, and outputs the detection accuracy to monitoring unit 72.

Monitoring unit 72 receives the detection accuracy from input unit 70. Based on the detection accuracy, monitoring unit 72 detects malfunction of sensor 22 for the obstacle. For example, monitoring unit 72 stores a threshold value for each type of sensors 22, and selects a threshold value corresponding to sensor 22 that has derived the input detection accuracy. Moreover, when the detection accuracy is lower than the threshold value as a result of comparing the detection accuracy and the threshold value with each other, monitoring unit 72 detects the malfunction. When having detected the malfunction, monitoring unit 72 notifies image generator 74 that the malfunction is detected.

Moreover, monitoring unit 72 receives, as the travel state of vehicle 100, the current speed from speed information acquisition unit 23 via I/O unit 43. Monitoring unit 72 stores a threshold value for the current speed separately from the above-mentioned threshold value, and compares the threshold value and the current speed with each other. If the current speed is the threshold value or less, then monitoring unit 72 determines that a current state of vehicle 100 is a normal travel state. Meanwhile, when the current speed is larger than the threshold value, monitoring unit 72 determines that the current state is a high-speed travel state. Note that, based on the current location acquired in location information acquisition unit 21 and the map information acquired in map information acquisition unit 24, monitoring unit 72 specifies a type of a road on which vehicle 100 is traveling. If the road is an ordinary road, monitoring unit 72 may determine that the current state is the normal travel state. If the road is an expressway, monitoring unit 72 may determine that the current state is the high-speed travel state. Monitoring unit 72 outputs a determination result to image generator 74. Furthermore, monitoring unit 72 receives information as to whether vehicle 100 is under autonomous driving or manual driving from autonomous driving control device 30 via I/O unit 43, and also outputs the received information to image generator 74.

Image generator 74 receives the direction of obstacle 220 from input unit 70, and receives, from monitoring unit 72, information on the detection of the operation/non-operation and malfunction of each of sensors 22, the normal travel state/high-speed travel state of vehicle 100, and the autonomous driving/manual driving of vehicle 100. Image generator 74 specifies an area that includes obstacle 220 based on the received direction of obstacle 220. FIG. 4 will be referred to again in order to describe this process. As illustrated, first area 200 is provided in front of vehicle 100, and second area 202 . . . , and eighth area 214 are sequentially provided clockwise from first area 200. In particular, third area 204 is provided on the right side of vehicle 100, fifth area 208 is provided on the rear of vehicle 100, and seventh area 212 is provided on the left side of vehicle 100. Here, a surrounding of vehicle 100 is divided into “eight”, whereby “eight” areas are defined. However, the number of areas is not limited to “eight”. Image generator 74 specifies eighth area 214, which includes obstacle 220, as a “detection area” based on the received angle “θ1” of obstacle 220. Note that, when having received directions of a plurality of obstacles 220, image generator 74 may specify a plurality of detection areas. The description returns to FIG. 3.

Moreover, when non-operating sensor 22 is present in the received operation/non-operation of each of sensors 22, image generator 74 specifies an area, which corresponds to such a detection range of sensor 22, as a “non-operation area”. Note that information regarding the area corresponding to the detection range of sensor 22 is stored in image generator 74 in advance for each sensor 22. For example, when sensor 22 of which detection range is the rear of vehicle 100 is under non-operation, image generator 74 specifies fifth area 208 as the non-operation area. Moreover, when having received the detection of the malfunction, image generator 74 specifies an area, which corresponds to the detection of the malfunction, as a “malfunction area”. The malfunction area overlaps the detection area; however, the malfunction area is given priority.

When having received the normal travel state, image generator 74 does not specify an area. However, when having received the high-speed travel state, image generator 74 specifies, as a “non-notification area”, an area corresponding to a detection range of sensor 22 that is not used in the high-speed travel state. Here, third area 204 and seventh area 212, which are the right and left areas of vehicle 100, are specified as such non-notification areas. As described above, in response to the travel state of vehicle 100, image generator 74 changes the ranges where sensors 22 are detectable. Moreover, image generator 74 selects a first color when having received the autonomous driving, and selects a second color when having received the manual driving. Here, the first color and the second color just need to be different colors from each other, and these colors just need to be set arbitrarily.

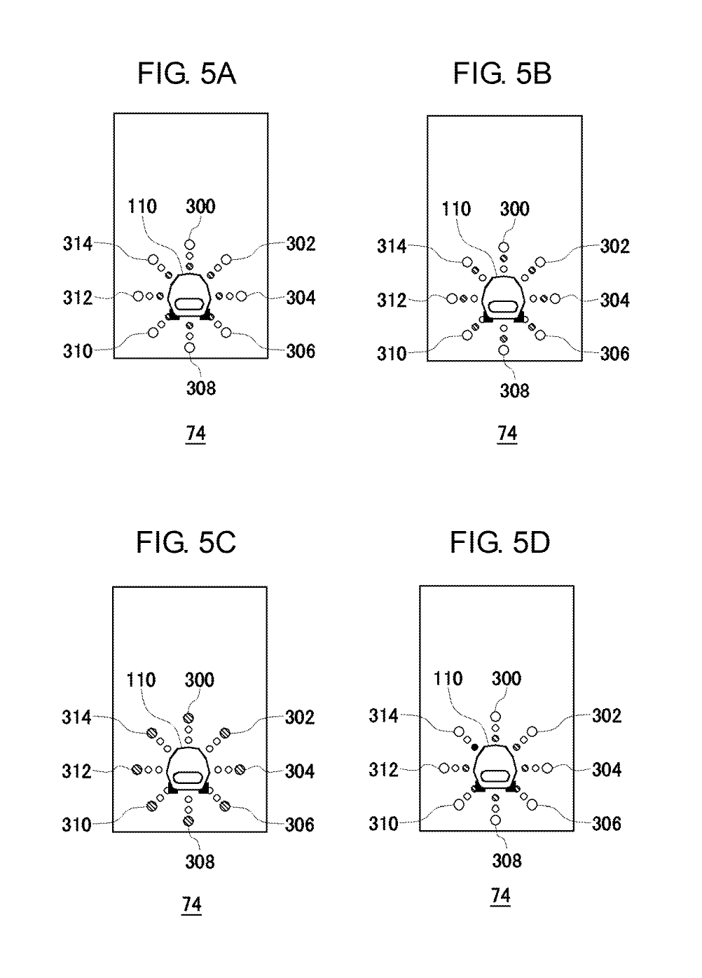

Image generator 74 generates image data corresponding to these processes. FIGS. 5A to 5F illustrate images generated in image generator 74. FIGS. 5A to 5C illustrate images when non-operating sensor 22 is not present, obstacle 220 is not detected, the malfunction is not detected, the state of vehicle 100 is the normal travel state, and vehicle 100 is under autonomous driving. Vehicle icon 110 corresponds to vehicle 100 in FIG. 4. Moreover, first area 300 to eighth area 314 correspond to first area 200 to eighth area 214 in FIG. 4, respectively. Each of first area 300 to eighth area 314 includes three round markers. When sensor 22 is operating, for example, repeated is a cycle in which the markers sequentially turn on and turn off after a predetermined time elapses from a center to an outside as shown in in FIGS. 5A to 5C. That is, the marker that is turned on is switched from the one closer to vehicle icon 110 to the one farther from vehicle icon 110. Two markers other than the one marker that is turned on are turned off. The cycle returns to FIG. 5A after FIG. 5C. Here, non-operating sensor 22 is not present, obstacle 220 is not detected, the malfunction is not detected, and the state of vehicle 100 is the normal travel state. Accordingly, first area 300 to eighth area 314 are displayed similarly to one another. That is, a notice on the operations of sensors 22 is issued by blinking of the markers. First area 300 to eighth area 314 as described above correspond to “non-detection areas”. Moreover, a background of the image is displayed by the first color.

FIGS. 5D to 5F illustrate images when non-operating sensor 22 is not present, obstacle 220 is detected, the malfunction is not detected, the state of vehicle 100 is the normal travel state, and vehicle 100 is under autonomous driving. That is, FIGS. 5D to 5F are different from FIGS. 5A to 5C in that obstacle 220 is detected. Here, as an example, obstacle 220 is detected in eighth area 214. Also here, similarly to the case of FIGS. 5A to 5C, the markers blink in order of FIGS. 5D to 5F, and a cycle of FIGS. 5D to 5F returns to FIG. 5D after FIG. 5F. However, a lighting color (illustrated in solid black) of the markers in eighth area 314 where obstacle 220 is detected is different from a lighting color (illustrated in shade) of the markers in other areas. That is, a notice on presence/non-presence of obstacle 220 is issued by the lighting colors of the markers. Here, eighth area 314 corresponds to the “detection area”, and first area 300 to seventh area 312 correspond to the “non-detection areas”.

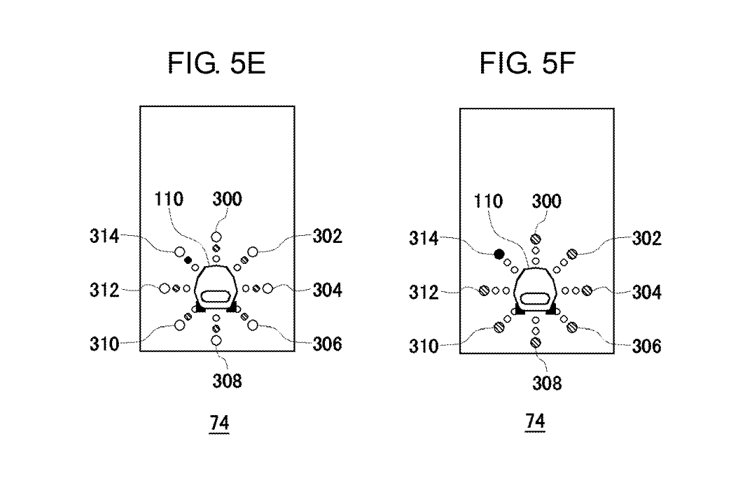

FIGS. 6A and 6B illustrate other images generated in image generator 74. FIG. 6A illustrates an image when non-operating sensor 22 is present, obstacle 220 is not detected, the malfunction is not detected, the state of vehicle 100 is the normal travel state, and vehicle 100 is under autonomous driving. That is, FIG. 6A is different from FIGS. 5A to 5C in that non-operating sensor 22 is present. Here, as an example, sensor 22 corresponding to eighth area 214 is non-operating. Moreover, also here, similarly to the case of FIGS. 5A to 5C, the markers blink while being switched for sensors 22 which are operating. However, a description of such operations as described above is omitted in the drawings in order to simplify the description. In first arear 300 to seventh area 312, which correspond to operating sensors 22, the markers blink similarly to FIGS. 5A to 5C. Meanwhile, three markers are not displayed on eighth area 314 corresponding to non-operating sensor 22. Accordingly, these three markers do not even blink. That is, a notice on the non-operation of sensor 22 is issued by non-display of the markers. Here, eighth area 314 corresponds to the “non-operation area”, and first area 300 to seventh area 312 correspond to the “non-detection areas”.

Also when the malfunction is detected, similar display to the case where non-operating sensor 22 is present is made. For example, in FIGS. 5D to 5F, obstacle 220 is detected in eighth area 314; however, when the malfunction is detected, three markers are not displayed on eighth area 314 as in FIG. 6A. Accordingly, these three markers do not even blink. That is, a notice on the non-operation of sensor 22 is issued by such non-display of the markers. Here, eighth area 314 corresponds to the “malfunction area”, and first area 300 to seventh area 312 correspond to the “non-detection areas”.

FIG. 6B illustrates an image when non-operating sensor 22 is not present, obstacle 220 is not detected, the malfunction is not detected, the state of vehicle 100 is the high-speed travel state, and vehicle 100 is under autonomous driving. That is, FIG. 6B is different from FIGS. 5A to 5C in that the state of vehicle 100 is the high-speed travel state. Moreover, also here, similarly to the case of FIGS. 5A to 5C, the markers blink while being switched for sensors 22 which are operating. However, a description of such operations as described above is omitted in the drawings in order to simplify the description. In the case of the high-speed travel state, three markers are not displayed on each of third area 304 and seventh area 312. Accordingly, these markers do not even blink. That is, a notice on the high-speed travel state is issued by such display of the markers on the right and left sides of vehicle icon 110. Here, third area 304 and seventh area 312 correspond to the “non-notification areas”.

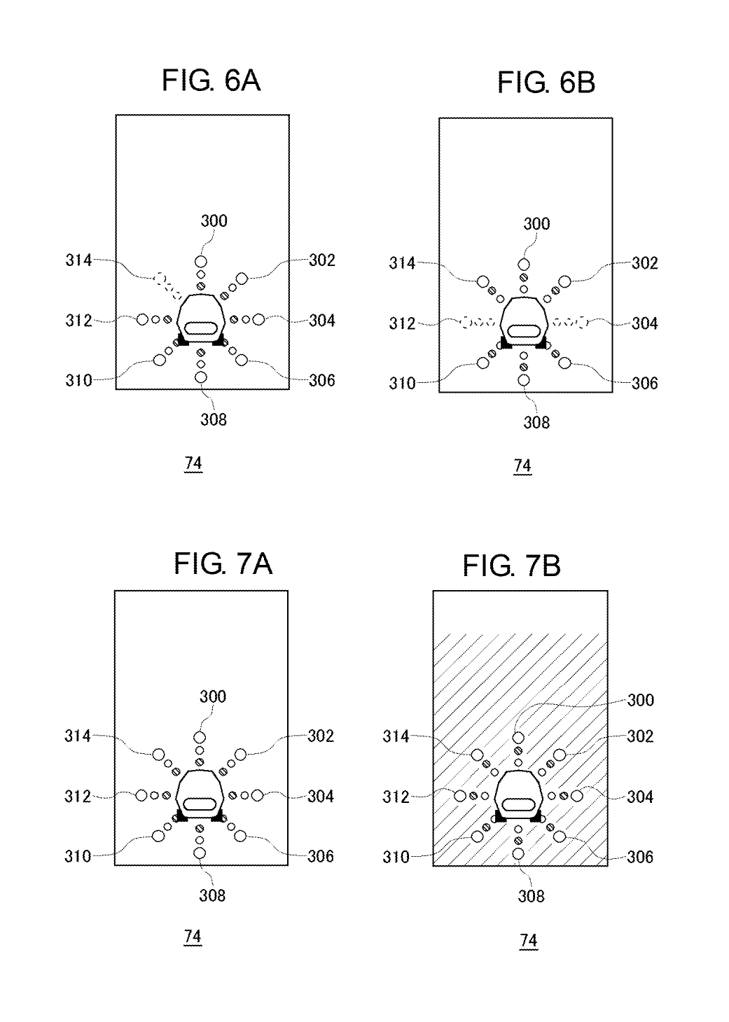

FIGS. 7A and 7B illustrate still other images generated in image generator 74. FIG. 7A is illustrated in a similar way to FIG. 5A, and illustrates the case where vehicle 100 is under autonomous driving. Moreover, unlike FIG. 7A, in FIG. 7B, a background of the image is displayed in a second color (illustrated in shade). FIG. 7B illustrates the case where vehicle 100 is under manual driving. That is, a notice on whether vehicle 100 is under autonomous driving or manual driving is issued based on the background color of the image. Here, in the case of the autonomous driving, the driver just needs to monitor autonomous driving control device 30 and an operation state of autonomous driving control device 30, and does not need to care about the direction of obstacle 220. Meanwhile, in the case of the manual driving, the driver needs to monitor a spot, which is to be cared about, in response to the detection result of sensor 22. A monitoring load on the driver varies as described above based on whether vehicle 100 is under autonomous driving or manual driving. Accordingly, a notice on the driving state is issued. The description returns to FIG. 3. Image generator 74 outputs the generated image data to output unit 76.

Output unit 76 receives the image data from image generator 74, and outputs the image to center display 2b in FIG. 2 via image/sound output unit 51 in FIG. 1. Center display 2b displays the image. Note that the image may be displayed on head-up display 2a in place of center display 2b. That is, output unit 76 outputs the information on the operation/non-operation of sensor 22 by the blinking/non-display of the markers. Output unit 76 also outputs the information on the detection/non-detection of obstacle 220 by the lighting color of the markers. Output unit 76 also outputs the information on the malfunction of sensor 22 by the blinking/non-display of the markers. Output unit 76 also outputs the information on the travel state of vehicle 100 by changing the area for which the markers are not displayed. Output unit 76 also outputs the information as to whether vehicle 100 is under autonomous driving or manual driving by the background color of the image. Note that autonomous driving control device 30 in FIG. 1 controls the autonomous driving of vehicle 100 based on the detection result of sensor 22.

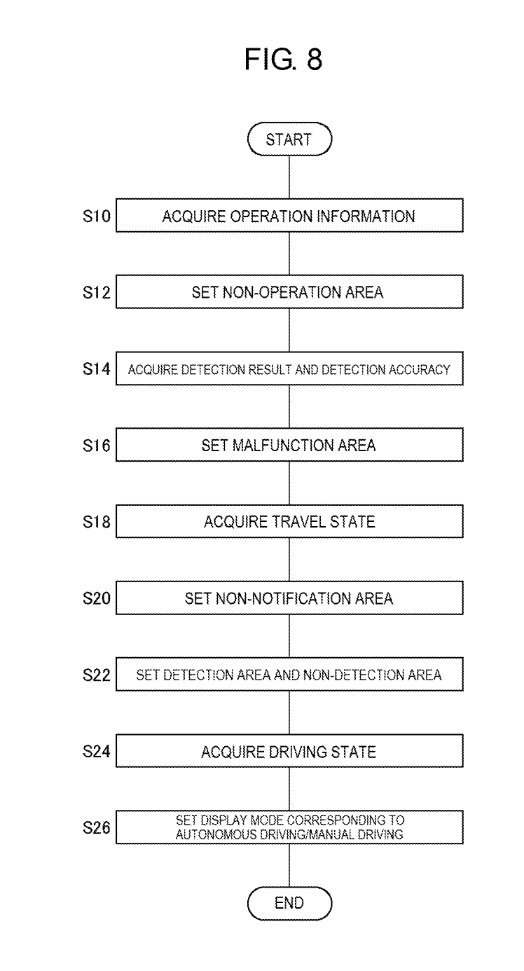

An operation of driving support device 40 having the above configuration will be described. FIG. 8 is a flowchart illustrating an output procedure by controller 41. Monitoring unit 72 acquires the operation information (S10), and image generator 74 sets the non-operation area (S12). Input unit 70 acquires the detection result and the detection accuracy (S14). When monitoring unit 72 detects the malfunction of sensor 22 based on the detection accuracy of sensor 22, which is received when sensor 22 is operating, image generator 74 sets the malfunction area (S16). Monitoring unit 72 acquires the travel state (S18), and image generator 74 sets the non-notification area (S20). Subsequently, image generator 74 sets the detection area and the non-detection area (S22). Monitoring unit 72 acquires the driving state (S24). Image generator 74 sets display modes corresponding to the autonomous driving/manual driving (S26). Based on these display modes set by image generator 74, output unit 76 also outputs the information on the malfunction together with the information on the operation/non-operation when monitoring unit 72 has detected the malfunction of sensor 22.

According to the present exemplary embodiment, the information on the malfunction of the sensor is also output together with the information on the operation/non-operation of the sensors. Accordingly, a notice on the information regarding the sensors mounted on the vehicle can be issued in a lump. Moreover, the information on the detection/non-detection of the obstacle is also output together with the information on the operation/non-operation of the sensors. Accordingly, the notice on the information on the sensors mounted on the vehicle can be issued in a lump. Moreover, the detectable ranges are changed and output in response to the travel state of the vehicle. Accordingly, the travel state of the vehicle and the detection ranges of the sensors can be recognized in association with each other. Furthermore, the information regarding the sensors is displayed collectively on one screen. Accordingly, it can be made easy for the driver to grasp the situation. Moreover, the background color is changed in response to whether the vehicle is under autonomous driving or manual driving. Accordingly, attention corresponding to whether the vehicle is under autonomous driving or manual driving can be urged to rise.

While the exemplary embodiment according to the present invention has been described above with reference to the drawings, the functions of the above-mentioned devices and processing units can be implemented by a computer program. A computer that achieves the above-mentioned functions through execution of a program is provided with an input device such as a keyboard, a mouse and a touch pad, an output device such as a display and a speaker, a central processing unit (CPU), a storage device such as a read only memory (ROM), a random access memory (RAM), a hard disk device and a solid state drive (SSD), a reading device for reading information from a recording medium such as a digital versatile disk read only memory (DVD-ROM) and a universal serial bus (USB) memory, and a network card that performs communication through a network. These units of the computer are interconnected with a bus.

The reading device reads the program from the recording medium recording the program therein, and the storage device stores the program. Alternatively, the network card performs communication with a server device connected to the network, and a program for implementing the respective functions of the above-described devices, the program having been downloaded from the server device, is stored in the storage device. Moreover, onto the RAM, the CPU copies the program stored in the storage device, and from the RAM, sequentially fetches instructions included in the program, and executes each of the instructions. In this way, the respective functions of the above-described devices are implemented.

An outline of an aspect of the present invention is as follows. A driving support device according to an aspect of the present invention includes: a monitoring unit that monitors whether a sensor to be mounted on a vehicle is operating; and an output unit that outputs operation-state information indicating a result of the monitoring by the monitoring unit. The monitoring unit detects malfunction of the sensor based on detection accuracy of the sensor. The detection accuracy is received when the sensor operates. The output unit malfunction information on the malfunction of the sensor together with the operation-state information when the monitoring unit detects the malfunction of the sensor.

According to this aspect, the information on the malfunction of the sensor is also output together with the information on the operation/non-operation of the sensors. Accordingly, a notice on the information on the sensors mounted on the vehicle can be issued in a lump.

The driving support device may further include an input unit that receives a detection result indicating a result of detection by the sensor. The output unit may output detection information together with the operation-state information. The detection information indicates a result of the detection received by the input unit. In this case, the information on the detection/non-detection of the obstacle is also output together with the information on the operation/non-operation of the sensor. Accordingly, a notice on the information regarding the sensors mounted on the vehicle can be issued in a lump.

The output unit may output the information in association with a range detectable by the sensor, the monitoring unit may also receive a travel state of the vehicle, and the output unit may change the detectable range of the information to be output in response to the travel state of the vehicle. In this case, the detectable range is changed and output in response to the travel state of the vehicle. Accordingly, the travel state of the vehicle and the detection range of the sensor can be recognized in association with each other.

The output unit may change an output mode in response to whether the vehicle is under autonomous driving or manual driving. In this case, attention corresponding to whether the vehicle is under autonomous driving or manual driving can be urged to rise.

Another aspect of the present invention provides an autonomous driving control device. This device includes: a monitoring unit that monitors whether a sensor to be mounted on a vehicle is operating; an output unit that outputs operation-state information indicating a result of the monitoring by the monitoring unit; and an autonomous driving controller that controls autonomous driving of the vehicle based on a detection result of the sensor. The monitoring unit detects malfunction of the sensor based on detection accuracy of the sensor. The detection accuracy is received when the sensor operates. The output unit outputs malfunction information on the malfunction of the sensor together with the operation-state information when the monitoring unit detects the malfunction.

Still another aspect of the present invention provides a vehicle. The vehicle includes a driving support device. The driving support device includes: a monitoring unit that monitors whether a sensor to be mounted on a vehicle is operating; and an output unit that outputs operation-state information indicating a result of the monitoring by the monitoring unit. The monitoring unit detects malfunction of the sensor based on detection accuracy of the sensor. The detection accuracy is received when the sensor operates. The output unit outputs malfunction information on the malfunction of the sensor together with the operation-state information when the monitoring unit detects the malfunction.

Yet another aspect of the present invention provides a driving support method. This method includes: monitoring whether a sensor to be mounted on a vehicle is operating; outputting operation-state information indicating a result of the monitoring by the monitoring unit; detecting malfunction of the sensor based on detection accuracy of the sensor, the detection accuracy being received when the sensor operates; and outputting malfunction information on the malfunction of the sensor together with the operation-state information when the malfunction of the sensor is detected.

The present invention has been described above based on the exemplary embodiment. It will be understood by those skilled in the art that the exemplary embodiment is merely an example, other exemplary modifications in which components and/or processes of the exemplary embodiment are variously combined are possible, and the other exemplary modifications still fall within the scope of the present invention.

### INDUSTRIAL APPLICABILITY

The present invention is applicable to a vehicle, a driving support method provided in the vehicle, a driving support device using the driving support method, an autonomous driving control device, a program, and the like.

### REFERENCE MARKS IN THE DRAWINGS

2 notification device
2a head-up display
2b center display
4 input device
4a first operating unit
4b second operating unit
6 speaker
8 wireless device
10 driving operating unit
11 steering
12 brake pedal
13 accelerator pedal
14 indicator switch
20 detector
21 location information acquisition unit
22 sensor
23 speed information acquisition unit
24 map information acquisition unit
30 autonomous driving control device
31 controller
32 storage unit
33 I/O unit
40 driving support device
41 controller
42 storage unit
43 I/O unit
50 operation input unit
51 image/sound output unit
52 detection information input unit
53 command IF
54 action information input unit
55 command output unit
56 communication IF
70 input unit
72 monitoring unit
74 image generator
76 output unit
100 vehicle
110 vehicle icon
200 first area
202 second area
204 third area
206 fourth area
208 fifth area
210 sixth area
212 seventh area
214 eighth area
220 obstacle
300 first area
302 second area
304 third area
306 fourth area
308 fifth area
310 sixth area
312 seventh area
314 eighth area

1. A driving support device comprising:
a monitoring unit that monitors whether a sensor to be mounted on a vehicle is operating; and
an output unit that outputs operation-state information indicating a result of the monitoring by the monitoring unit,
wherein the monitoring unit detects malfunction of the sensor based on detection accuracy of the sensor, the detection accuracy being received when the sensor operates, and
the output unit outputs malfunction information on the malfunction of the sensor together with the operation-state information when the monitoring unit detects the malfunction of the sensor.

2. The driving support device according to claim 1, further comprising an input unit that receives a detection result indicating a result of detection by the sensor,
wherein the output unit outputs detection information together with the operation-state information, the detection information indicating a result of the detection received by the input unit.

3. The driving support device according to claim 1, wherein
the output unit outputs information in association with a range detectable by the sensor,
the monitoring unit receives a travel state of the vehicle, and
the output unit changes the detectable range of the information to be output in response to the travel state of the vehicle.

4. The driving support device according to claim 1, wherein the output unit changes an output mode in response to whether the vehicle is under autonomous driving or manual driving.

5. (canceled)

6. A vehicle provided with a driving support device, wherein
the driving support device includes:
a monitoring unit that monitors whether a sensor to be mounted on a vehicle is operating; and
an output unit that outputs operation-state information indicating a result of the monitoring by the monitoring unit,
the monitoring unit detects malfunction of the sensor based on detection accuracy of the sensor, the detection accuracy being received when the sensor operates, and
the output unit outputs malfunction information on the malfunction of the sensor together with the operation-state information when the monitoring unit detects the malfunction.

7. A driving support method comprising:
monitoring whether a sensor to be mounted on a vehicle is operating; and
outputting operation-state information indicating a result of the monitoring by the monitoring unit,
wherein the monitoring includes detecting malfunction of the sensor based on detection accuracy of the sensor, the detection accuracy being received when the sensor operates, and
in the outputting, malfunction information on the malfunction of the sensor is outputted together with the operation-state information when the malfunction of the sensor is detected.

8. (canceled)

9. The vehicle according to claim 6, further comprising an input unit that receives a detection result indicating a result of detection by the sensor,
wherein the output unit outputs detection information together with the operation-state information, the detection information indicating a result of the detection received by the input unit.

10. The vehicle according to claim 6, wherein
the output unit outputs information in association with a range detectable by the sensor,
the monitoring unit receives a travel state of the vehicle, and
the output unit changes the detectable range of the information to be output in response to the travel state of the vehicle.

11. The vehicle according to claim 6, wherein the output unit changes an output mode in response to whether the vehicle is under autonomous driving or manual driving.

12. The driving support method according to claim 7, further comprising receiving a detection result indicating a result of detection by the sensor,
wherein in the outputting, detection information is outputted together with the operation-state information, the detection information indicating a result of the detection received by the input unit.

13. The driving support method according to claim 7, wherein
in the outputting, information is outputted in association with a range detectable by the sensor,
the monitoring includes receiving a travel state of the vehicle, and
in the outputting, the detectable range of the information to be output is changed in response to the travel state of the vehicle.

14. The driving support method according to claim 7, wherein in the outputting, an output mode is changed in response to whether the vehicle is under autonomous driving or manual driving.
